(19) United States
(12) Patent Application Publication
(10) Pub. No.: US 2008/0264838 A1
(43) Pub. Date: Oct. 30, 2008

(54) Sorting Center and Method for Sorting and Combining Mail and a Sorting Cabinet and Buffer Assembly for Use Therein

(76) Inventor: Barbara Limpens, Den Haag (NL)

Correspondence Address: HOFFMANN & BARON, LLP, 6900 JERICHO TURNPIKE, SYOSSET, NY, 11791, US

(21) Appl. No.: 11/884,624

(22) PCT Filed: Feb. 16, 2005
(86) PCT No.: PCT/NL05/00110

§ 371 Date: Apr. 11, 2008

(51) Int. Cl. B07C 7/02; B07C 3/00

(52) U.S. Cl. 209/703; 209/630

(57) ABSTRACT

The invention relates to a sorting center for sorting and combining mail, comprising sorting units in particular sorting cabinets, for hand-sorting mail and combining units, in particular combining tables, for combining into a single mail flow hand-sorted and other mail which has for instance already been sorted earlier or has been machine-sorted. The combining units are then physically separated from the sorting units and can be used independently thereof, so that sorting and combining can take place independently of each other.

The invention further relates to a method for sorting and combining mail, and a sorting cabinet, a buffer assembly for use in a sorting center and method according to the invention.

The invention relates to a sorting center and method for sorting and combining mail, such as letters, packages, newspapers, magazines or such delivery goods, and unaddressed mail such as printed matter, (advertising) brochures or the like.

Before mail can be delivered, it must be sorted in sorting centers destined thereto to destination, for instance country, province, postal code, district, street and/or house number. To a large extent, this sorting is carried out automatically or by machine, with the aid of sorting machines suitable thereto. However, a portion of the mail cannot be processed by such machines, for instance because the size of the mail is too large or too small or because the destination is unclear or incorrect or has been provided at a deviating, unreadable position. This mail must be sorted by hand. Thus, as a rule, at least two mail flows are formed in a sorting center: one machine-sorted flow and one hand-sorted flow. In addition, in such sorting centers, mail flows can arrive which may, for instance, have been roughly sorted elsewhere, for instance to region or district, and are then sorted further in the respective center, or mail flows needing no sorting, such as unaddressed mail. After, optionally, having been automatically sorted or hand-sorted, these separate flows are combined to form one new, sorted flow and are then bundled to form delivery units.

Traditionally, the hand-sorting, combining and bundling of the mail is carried out per delivery area by the very person who delivers the mail in this area. This offers the advantage that already when sorting and combining, the deliverer, who knows his delivery area well, can for instance take into account a particular order of delivery and/or further specifics of his delivery area. For sorting and combining, use is made of sorting cabinets which are subdivided into sorting cubicles which are each provided with a sorting destination belonging to a particular delivery area. The sorting cabinets further comprise a worktop for combining hand-sorted mail from the cabinet with other mail flows mentioned earlier. As all processes are carried out by one and the same person, at a predetermined workplace, this manner of working has hardly any continuity problems between successive processing steps, such as supply shortages and associated waiting times, or supply surpluses.

In order to operate more efficiently, it is desirable to have the delivery of mail done by unspecialized personnel. However, to that end, it is required that the mail can be delivered to a deliverer at an arranged place and time. This is difficult to realize with the known sorting centers and method because the sorting and combining units are not flexibly usable and therefore, bottlenecks can hardly, if at all, be reacted to.

The object of the invention is to provide a method of the type described hereinabove, with which at least a part of the drawbacks of the known method is avoided while its advantages are maintained. To that end, the method according to the invention is characterized by the features of claim 1.

By separating the combining units from the sorting units, the two can be utilized completely independently of each other, for instance simultaneously, by different persons and for the purpose of different mail flows. As a result, manpower and means can be used more flexibly so that bottlenecks can be reacted to more efficiently. When, for instance, the processing of a particular amount of mail for a particular delivery area threatens to take longer than is planned, for instance because the amount is larger than usual, sorting and combining this mail can, in part, be carried out simultaneously instead of sequentially. In addition or alternatively, the amount of mail can be divided into smaller portions, which can be processed parallelly on the different units.

Further, the uncoupled sorting and combining units according to the invention can be used more efficiently. On average, combining mail takes twice as long as hand-sorting it. That is why in the traditional sorting centers, the sorting cabinets are unused for a substantial part of the time. Owing to the physical uncoupling according to the invention, the cabinets can be used continuously so that approximately half the sorting cabinets can suffice. The space that becomes available in this manner can for instance be provided with one or more buffers for storing mail temporarily, according to the features of claim 2.

Due to such buffers, temporary highs and lows in the various mail flows can be accommodated, waiting times can be avoided and a certain degree of freedom is created so that manpower and means can be used more flexibly, for instance for combating potential bottlenecks more effectively.

In an advantageous embodiment, at least a part of these buffers can be designed so as to be wheeled, according to the features of claim 4, and hence perform a double function, that of storage means and of transport means. As a result, the number of auxiliary means can be minimized and space can be saved.

In a particularly advantageous embodiment, the buffers and/or transport means can be provided with destination-restricted storage positions, according to the features of claim 5. Due to such storage positions, the different mail flows still to be combined for a particular delivery area can be grouped in a simple and well organized manner, while verification whether all flows for a particular delivery area are complete is relatively simple, so that combining can start. Thus, it can also be determined in a relatively simple manner which mail flows are still missing, and bottlenecks can therefore be identified in an early stage.

In further elaboration, the transport means or mobile buffer parts can serve as pass-on point from which, after arrival at a processing station, mail can be presented to a user in an ergonomically safe and well-organized manner. To that end, the buffer and/or transport means can be provided with different storage levels, according to the features of claim 6, so that, each time, the mail can be presented from a most suitable height, for each processing unit and user.

In a further advantageous embodiment, the transport means or mobile buffer parts can be provided with guide means according to the features of claim 7 for positioning it correctly relative to a processing unit, which can be provided with cooperating guide means. With this, a correct, unambiguous positioning can be imposed without a user, to that end, needing to have any knowledge of the process.

The invention further relates to a sorting cabinet, provided with cubicles with programmable identification means according to the features of claim 9. As a result, the destination indication of the respective sorting cubicles can each time be changed in a simple manner, so that a very flexibly usable sorting cabinet is obtained, suitable to be used for various delivery areas. Programming the identification means can be carried out manually, yet is preferably done via pre-programmed sorting programs stored in the sorting cabinet, so that, prior to a sorting session, a user only needs to select the desired delivery area and the corresponding program.

It will be clear that due to this flexible usability, such a sorting cabinet is eminently suitable for use in a sorting center according to the invention, but is not limited to such a use. The sorting cabinet can for instance be advantageously used in other sorting environments and/or other sorting methods, without the limitative features according to the main claim.

In further elaboration, the sorting programs can comprise further relevant information, for instance with regard to the order of the destinations below the sorting cubicles, for instance arranged alphabetically from left to right or from top to bottom or vice versa, which order, if desired, may be adapted to the personal wishes of a user or more general user characteristics such as left-handedness or right-handedness. The destinations can for instance be aligned to the left hand side for left handed people and aligned to the right hand side for right-handed people. The program can further contain information regarding the order of delivery of the destinations, so that the cubicles can be emptied in this order. Such pre-programmed knowledge may help simplify sorting and enables a more flexible use of personnel, as they need hardly have any specific knowledge of the sorting and/or delivery process.

In an advantageous embodiment, the sorting cabinets are preferably height and/or width-adjustable, according to the features of claim(s) 12 and/or 13. Because of this, a working height or width of the sorting cabinet can be adjusted to the physique of a user, in particular his reach length-wise or width-wise so that the cabinets and users can be used even more flexibly, unhindered by physical discomfort. Adjusting the working height and or width can for instance be carried out via electromechanical or hydraulic means. Alternatively, the sorting cabinet may comprise pivotable parts, with which the mutual position of the sorting cubicles, and hence a working height and/or width, can be adjusted.

In a particularly advantageous embodiment, the sorting cabinet comprises more sorting cubicles than sorting destinations, so that the working height and/or width can be adjusted by using only a number of the available rows and/or columns of sorting cubicles, for instance only the top rows (for relatively tall users), the most centrally located columns (resulting in a smaller required reach) and/or the columns located most to the left or the right (for left-handed and right handed people, respectively).

These settings can be pre-programmed in earlier mentioned sorting programs or in separate user profiles. Preferably, the control of the sorting cabinet is arranged such that setting such person-restricted working conditions is mandatory. This is beneficial to the ease of use and comfort.

The invention further relates to a buffer assembly according to the features of claim 19, comprising a static buffer part and at least one wheeled buffer part which can be coupled to the static part and can thus increase the buffer capacity, or can be uncoupled and can thus serve as transport means. As a result, space and means can be saved because no separate transport means are required.

In a further elaboration, a buffer assembly according to the invention is preferably characterized by the features of claim 20. By providing the static buffer part with transport means, mail (or other goods) can simply be manoeuvred to a desired storage position in the static buffer part or the wheeled buffer part. The blocking means ensure that mail can only be transported into the wheeled part when this part has actually been linked up.

It is noted that a buffer assembly according to the invention is not limited to use in a sorting centre according to the invention but can also be advantageously used in other logistic processes where goods are be to be temporarily stored.

The invention further relates to a method for sorting and combining mail according to the features of claim 23. Due to the uncoupling of hand-sorting and combining, a much more flexible process is obtained in which manpower and sorting and combining units can be used, to a large extent, independently of each other, and sorting and combining operations can take place, at least in part, parallelly instead of sequentially. Further, in particular the sorting units can be utilized more optimally so that fewer means can suffice.

In the further subclaims, further advantageous embodiments are described of a sorting center and method according to be invention and a sorting cabinet and buffer assembly to be used therewith.

In clarification of the invention, an exemplary embodiment of a sorting center and a method to be used therein according to be invention will be further elucidated with reference to the drawing. In the drawing:

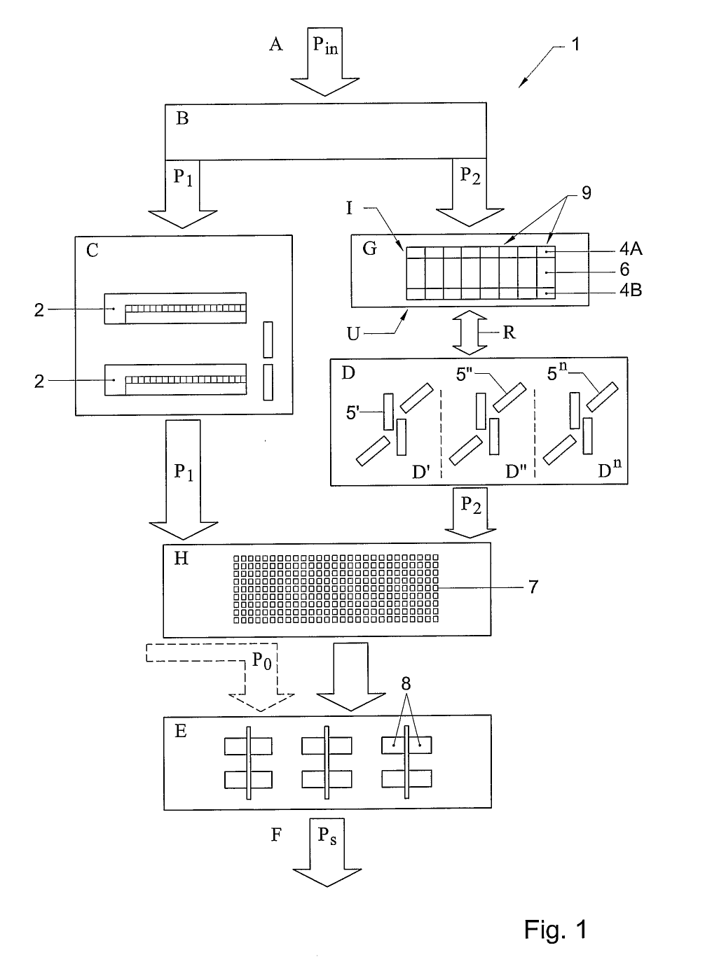

FIG. 1 shows, in schematic top plan view, an embodiment of a sorting center according to the invention, for sorting and combining mail;

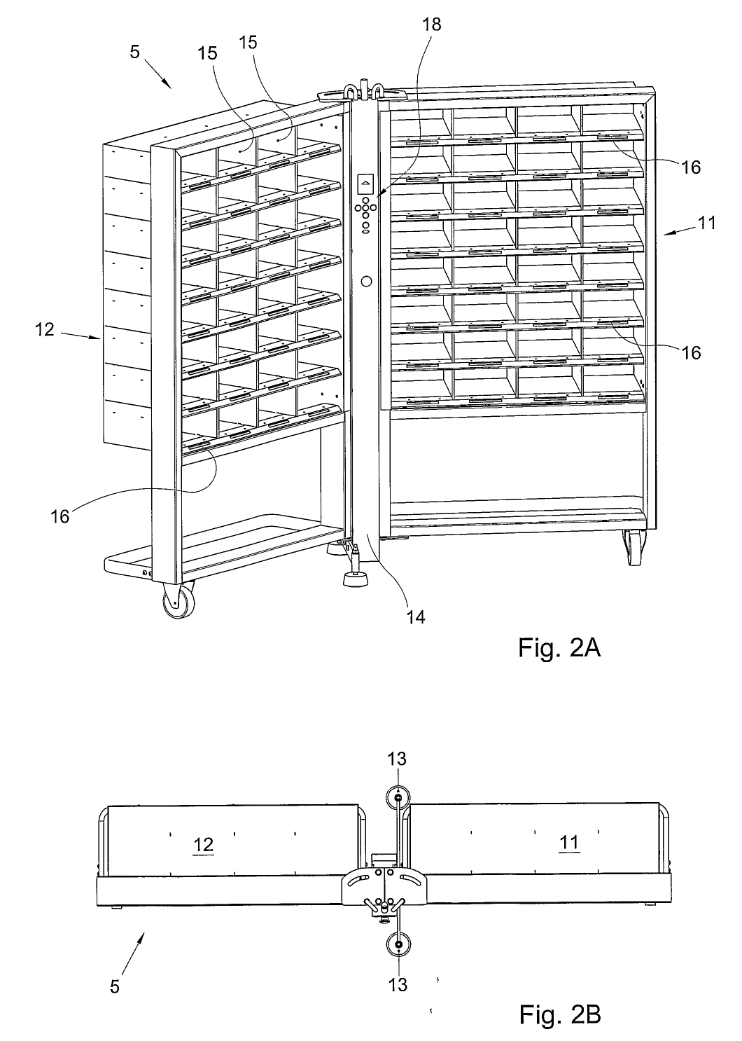

FIGS. 2A, B show, in perspective and top plan view, respectively, an embodiment of a sorting cabinet according to invention, suitable for use in a manual sorting zone of a sorting center according to FIG. 1;

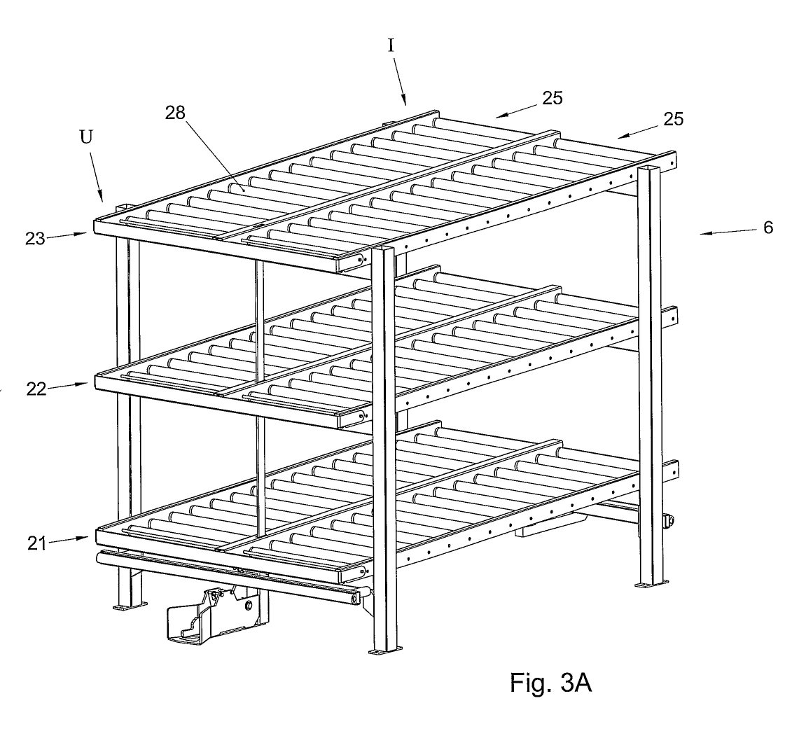

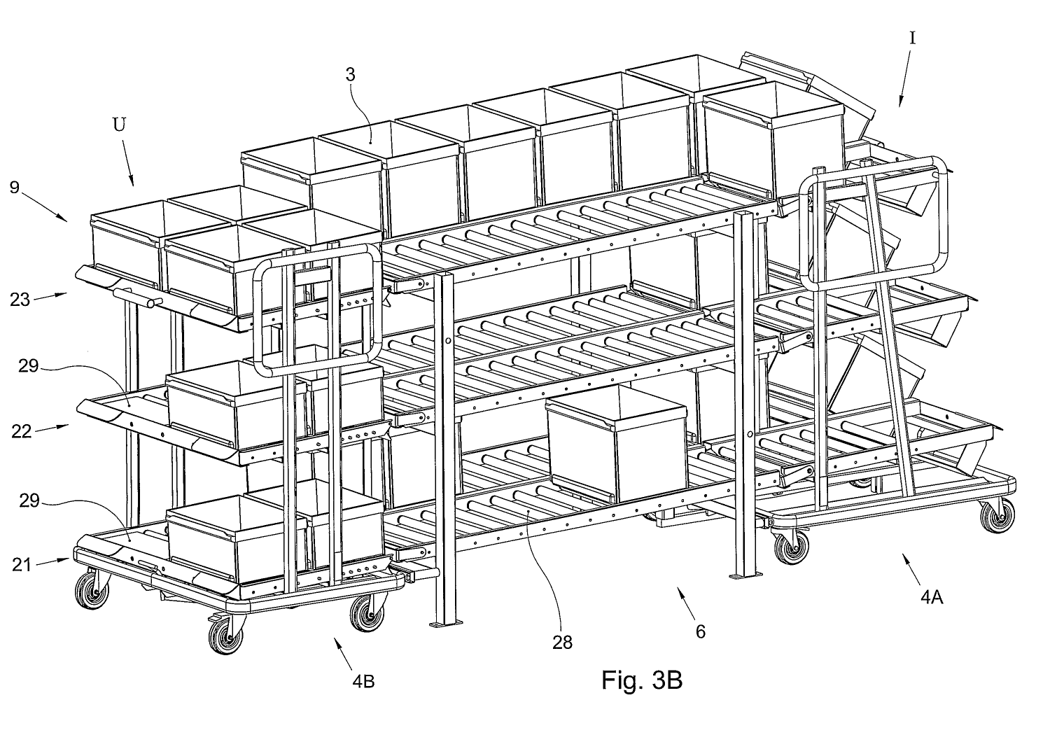

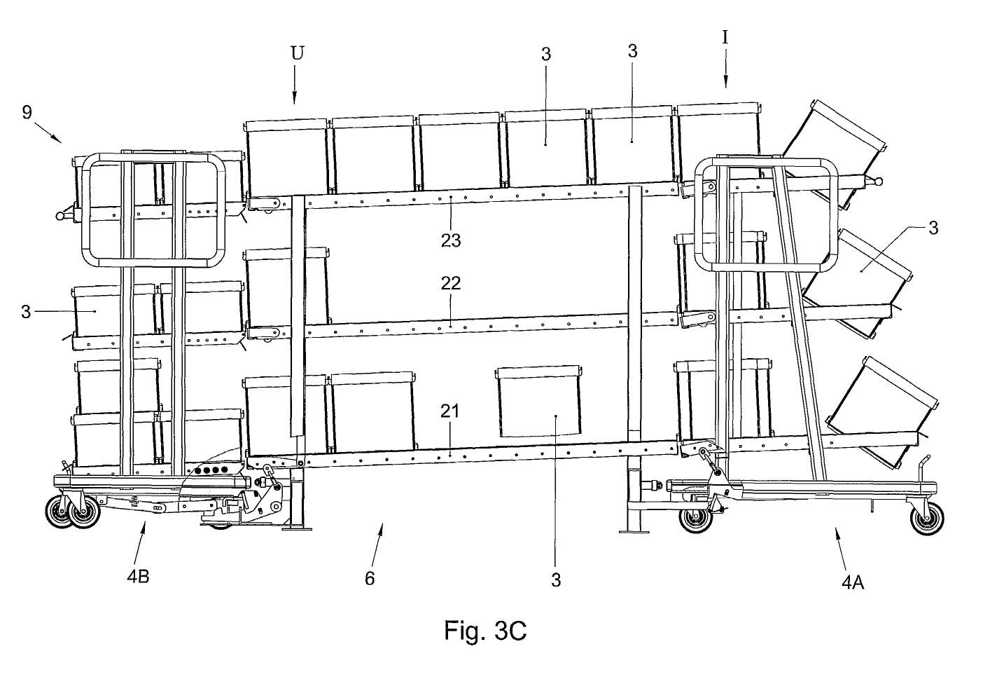

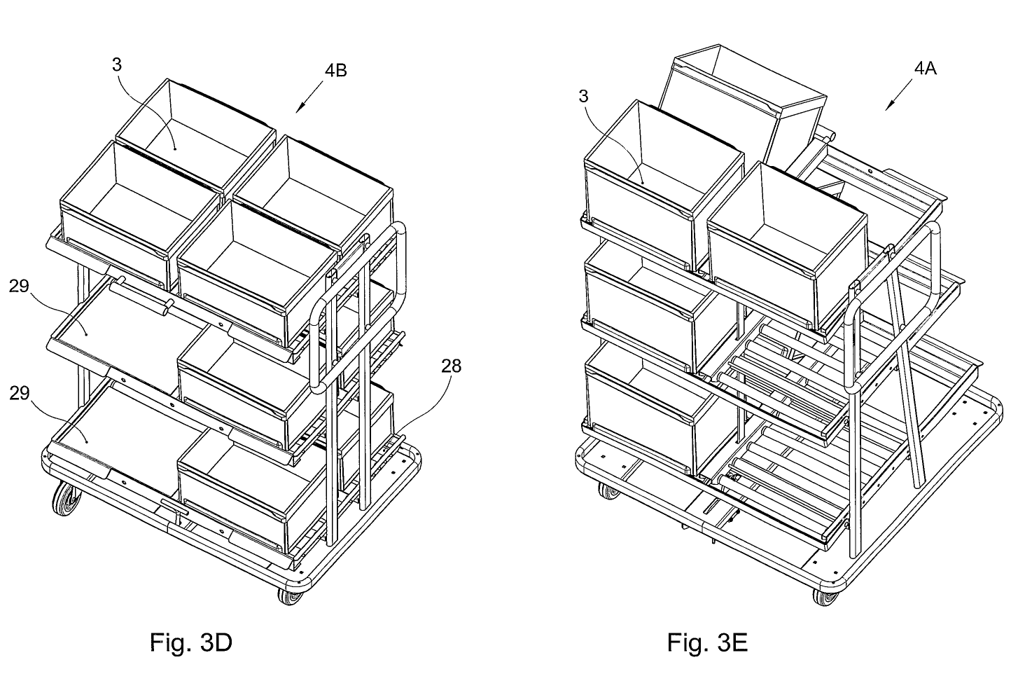

FIG. 3A shows, in perspective view, an embodiment of a buffer for sorting out mail for use in a sorting center according to FIG. 1;

FIGS. 3B, C show a buffer assembly with the buffer according to FIG. 3A and transporting trolleys linking up therewith, in perspective view and side view, respectively;

FIGS. 3D, E show in further detail the transport trolleys from FIGS. 3B and 3C in perspective view;

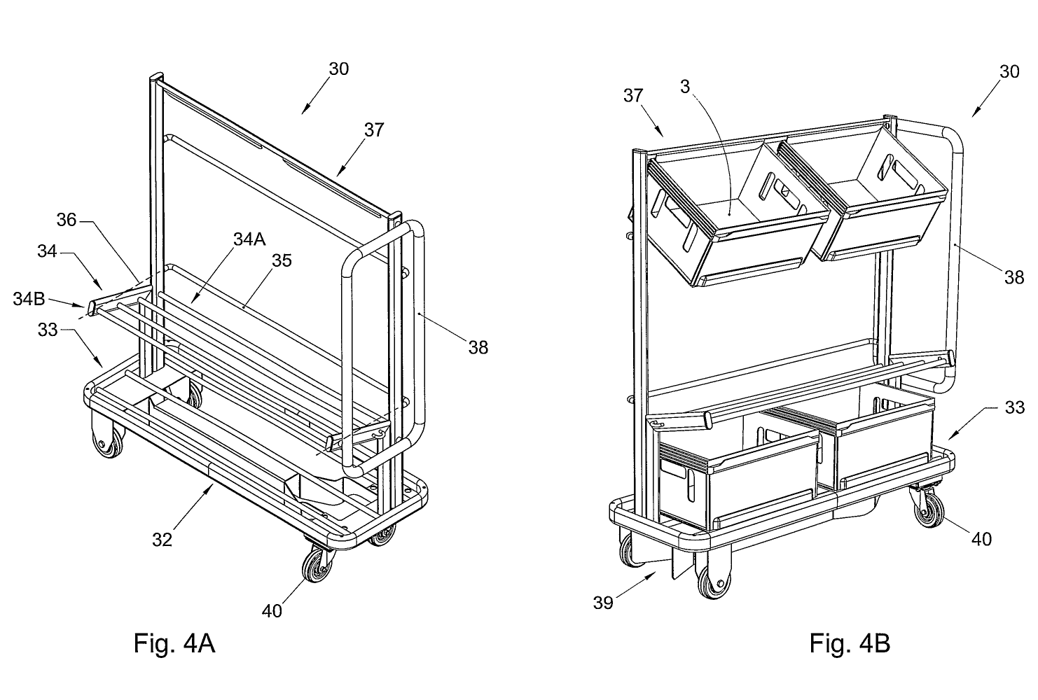

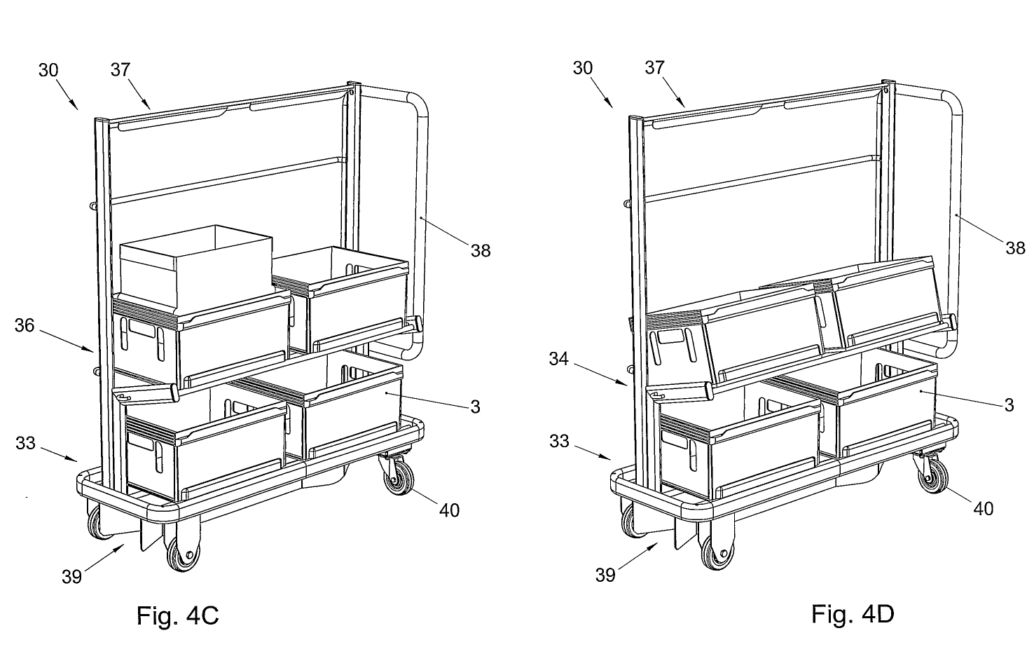

FIG. 4A shows, in perspective view, an embodiment of a combining trolley, for use in a sorting center according to FIG. 1;

FIGS. 4B, C, D show the combining trolley according to FIG. 4A, provided with mail carriers, in three different positions, suitable for emptying a sorting cabinet, temporarily storing hand-sorted and automatically-sorted mail, combining mail and packaging combined mail in, for instance, an inner bag for obtaining manageable bundles of combined mail, respectively;

FIG. 5 shows, in perspective view, an embodiment of a transport trolley for use in a sorting center according to FIG. 1, for transporting mail flows between the different zones;

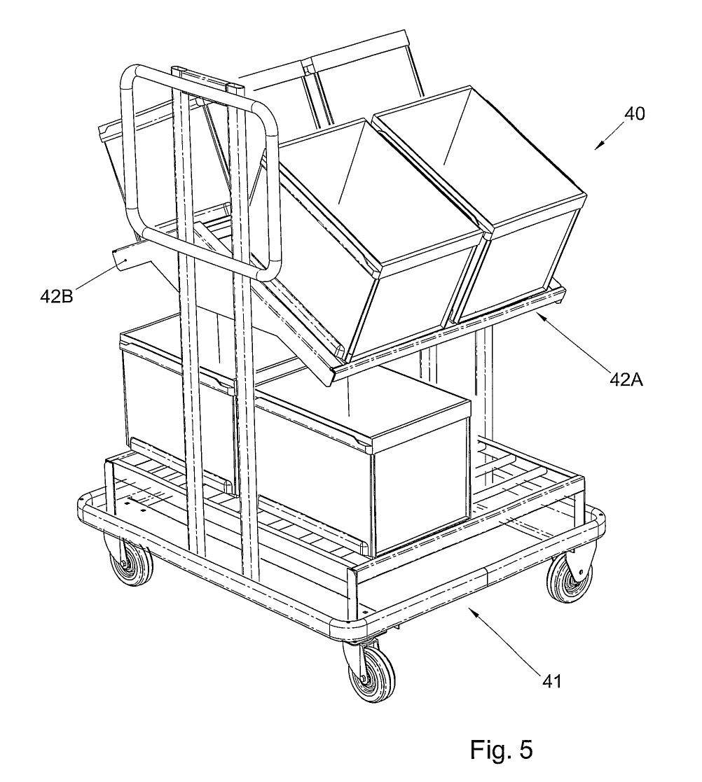

FIG. 6 shows, in perspective view, a combining unit for use in a combining zone of a sorting center according to FIG. 1;

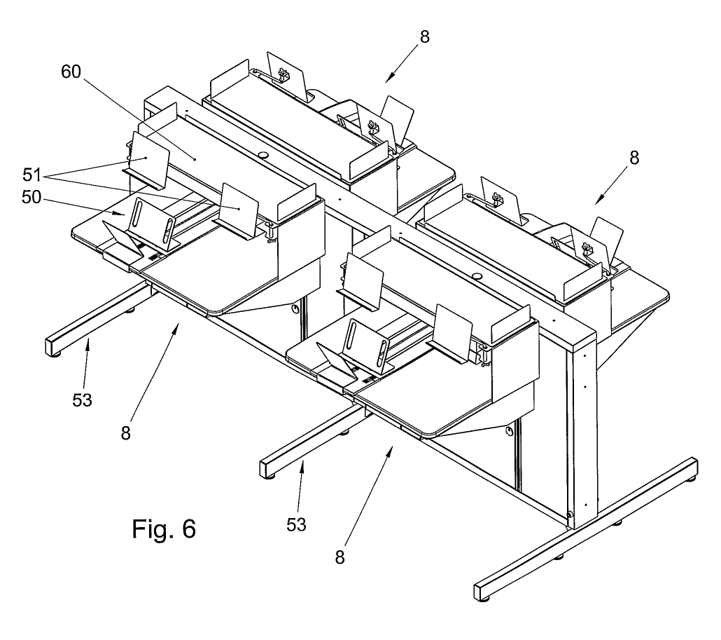

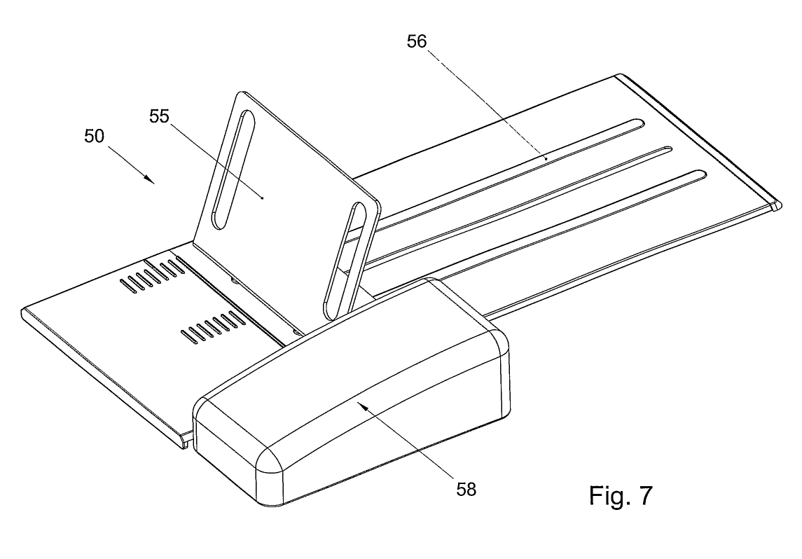

FIG. 7 shows in further detail a combining auxiliary means of the combining unit of FIG. 6; and

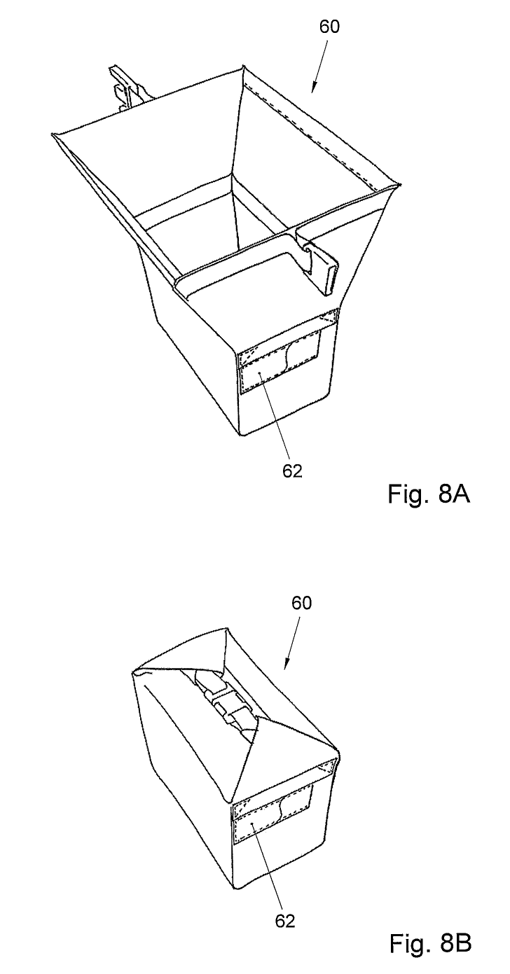

FIGS. 8A, B show an example of an inner bag for packaging combined, bundled mail, in opened and closed position, respectively.

In this description, identical or corresponding parts have identical or corresponding reference numerals. In the following description, the invention will be elucidated with reference to mail which is sorted to street and street number. However, sorting mail can take place on other levels, for instance to country, province, region or postal code. It is expressly noted that a sorting center and method according to the invention can be used with each of these sorting levels, and are therefore not limited to the sorting level described hereinbelow.

FIG. 1 schematically shows, in top plan view, a mail sorting center 1 according to the invention, provided with a number of processing stations or zones, indicated with capitals A-F, where mail P is successively sorted and combined. The center 1 comprises a feed zone A for incoming mail Pᵢₙ, a pre-sorting zone B for separating the incoming mail Pᵢₙ into automatically sortable mail P₁, mail P_{2,n}, to be hand-sorted, and, optionally, unaddressed mail P_{O}, a first sorting zone C for automatically sorting mail P₁, a second sorting zone D for hand-sorting mail P_{2,n}, a combining zone E for combining the different mail flows P_{1, 2,n} and optionally unaddressed mail P_{O} to form one flow of sorted mail Pₛ and a dispatch zone F for further distribution of the combined mail Pₛ. Further, between the processing zones A-F, a number of buffers can be provided, for storing mail P temporarily. For instance, the exemplary embodiment shown in FIG. 1 comprises two buffers, i.e. a buffer G for sorting out mail, between the pre-sorting zone B and the hand-sorting zone D, and a combining buffer H between the sorting zones C, D and the combining zone E.

The sorting center 1 functions as follows. The feed zone A is arranged for receiving incoming mail Pᵢₙ once or several times a day. In the example shown, this incoming mail Pᵢₙ has already been sorted to postal code and possibly already to district. In this description, a district is understood to mean a delivery area which is operated by one deliverer. Such a district is also called a “round” in the jargon and, as a rule, comprises an amount of delivery addresses which, together, represent a particular amount of delivery work and/or delivery time.

The incoming mail Pᵢₙ is manually separated in the pre-sorting zone B into a first mail flow P₁ which can be sorted further by automatic means, and a second mail flow P₂ which cannot be automatically sorted, for instance because this mail P₂ is too large or too small, or because the address cannot be automatically identified, for instance because it is unreadable or has been provided at an unreadable position. The incoming mail Pᵢₙ can, for that matter, already have been separated in an earlier stage, before entering the sorting center 1, into a first flow of mail P₁ to be automatically sorted and a second flow of mail P₂ to be hand-sorted. In that case, the pre-sorting zone B can naturally be omitted.

The separated flows P_{1,2} can be accommodated in mail carriers 3. In the example shown, these are designed as rectangular crates but can naturally also be designed differently, for instance as mailbags. However, crates 2 offer the advantage that therein, the mail P1, 2 can be arranged neatly and well-organized and can be adequately protected against damaging influences. Furthermore, crates can be manipulated and stacked in a simple manner and may have fixed, standardized sizes to which the further auxiliary means such as transport trolleys and buffers can be adjusted. Preferably, the mail carriers 3 are provided with an individual characteristic appearance per type of mail P_{1,2}, for instance by means of distinguishing colors, sizes and/or designs. As a result, the different mail flows P_{1,2} remain easily recognizable during at least a part of the further processing path. This is beneficial to the transparency of the process and may help prevent mistakes.

The first mail flow P₁ is brought from the pre-sorting zone B to the automatic sorting zone C, where this mail P₁ is sorted by a sorting machine 2 to district (if this had not been done already), street and house number. As such sorting machines 2 are adequately known per se, they need not be further described here. In an alternative embodiment, the first mail flow P₁ may already have been sorted to street and house number at an earlier location. In that case, the pre-sorting zone B and automatic sorting zone C described hereinabove can be left out or omitted. The thus sorted mail P₁ is then brought to the combining zone E or is first stored in the combining buffer H provided to that end. Transport can for instance be carried out by means of a transport trolley as indicated in FIG. 5, which will be discussed further in the following.

Preferably, the combining buffer H comprises district-restricted storage locations, intended for mail carriers 3 with mail for a specific district. If desired, these storage locations can be designed to be mobile, for instance as combining trolley 7, a possible exemplary embodiment of which will be described further in the following with reference to FIGS. 4A-D.

With the first mail flow P₁ thus traversing zone C, the remaining mail P₂ is brought from the pre-sorting zone B to the manual sorting zone D or buffer for sorting out mail G, to be temporarily stored. For this transport, use can be made of special trolleys 4A, B which will be further described hereinbelow with reference to FIGS. 3C-E. In the sorting zone D the mail P₂ is manually sorted further, by means of sorting units 5 suitable thereto such as, for instance, sorting cabinets 5 as shown in FIGS. 2A, B. This manual sorting operation can take place in one or several steps, depending on the level at which the mail P₂ has already been pre-sorted. For instance, the mail P₂ can first be sorted to district, then to street and then, optionally, (although this is unusual) to house number. To that end, the sorting zone D can be subdivided into several successive partial zones D′, D″, . . . Dⁿ, as represented in FIG. 1 in interrupted lines, while each partial zone D′, D″, . . . Dⁿ can be provided with separate sorting cabinets 5′, 5″, 5ⁿ, designed for the sorting step involved. Alternatively, the sorting zone D can be traversed repeatedly, while the mail P₂ is stored between the successive sorting steps in the buffer for sorting mail G. This is schematically indicated in FIG. 1 with arrow R. In this latter case, each time, the same sorting cabinets 5 can be used for the successive sorting steps, while the sorting destinations of those cabinets 5 are however changed each time, for instance in a manner as will be further elucidated hereinafter with reference to FIG. 2A.

After the mail P2 has thus been hand-sorted, it is taken from the sorting units 5 and placed, in order, in new mail carriers 3, while it is preferred that this order coincides with the order of the machine-sorted mail (in zone C), which order, in turn, preferably coincides with the delivery order or the order in which the mail will eventually be delivered. The mail carriers 3 can again have an individual, recognizable appearance, so that it is directly clear that they contain (hand-) sorted mail P₂. Then, the mail P₂ is brought to the combining zone E or the combining buffer H, where the mail can be temporarily stored, preferably to district, like the first mail flow P₁.

The combining zone E comprises a number of combining units of which in FIG. 6 a possible embodiment is shown. Preferably, these combining units are wheeled and comprise, in the exemplary embodiment shown, four combining tables 8. Naturally, in alternative exemplary embodiments, the units may comprise more or fewer combining tables 8. In the example shown, each combining table 8 is provided with a separate combining auxiliary means 50 to be discussed hereinafter, as shown in FIG. 7, and one or more stands or clipboards 51 for attaching information sheets for the instruction of the combining personnel. The combining tables 8, in particular their legs, can further serve as positioning provision 53 for the purpose of correctly positioning a combining trolley 7, which combining trolley 7 can be provided to that end with guiding channels 39 cooperating with the legs as will be further elucidated hereinafter.

The combining means 50 (FIG. 7) comprises a slightly backward sloping supporting part 55, and a guiding provision 56 in the form of two guiding grooves or rails, in which this supporting part 55 can be moved forward and backward, over the top of the combining table 8. The combining means 50 can further comprise an arm support 58. In use, a stack of mail P₁ machine-sorted to house number is placed against the supporting part 55, while the backward sloping position ensures that the addresses are well visible. Then, hand-sorted mail P₂ is inserted into this stack so that per district, one flow of combined mail Pₛ is obtained, sorted to street and house number. As the combined flow Pₛ grows, manageable bundles can be formed which can be temporarily stored on a shelf 60 especially provided to that end above each table 8 (see FIG. 6). These bundles can for instance be geared to a particular maximum carrying weight, volume or a particular amount of work and/or time involved with delivery. During combining, the supporting part 55 of the combining auxiliary means 50 can be gradually moved forward until an entire district or subdistrict has been combined. Optionally, in the combining zone E, unaddressed mail P_{O} can be added such as advertising brochures, printed matter and the like as is represented in FIG. 1 with an arrow drawn in interrupted lines. However, such unaddressed mail P_{O} can also be added later (outside the sorting center 1) for instance by a deliverer, just before he delivers the mail to a final destination.

The bundles of mail Pₛ are then packaged to delivery order in suitable transport volumes, for instance an inner bag 60 as depicted in FIGS. 8A, B and thus, via dispatch zone F be discharged from the sorting center 1. As to design, the inner bag 60 is preferably geared to the earlier formed bundles and further preferably designed such that it can be taken up in its entirety in a delivery bag or similar delivery means of a deliverer such as a bicycle bag or delivery trolley. Thus, the inner bag 60 forms a relatively inexpensive generic packing means, for facilitating transport to and transfer from sorted mail to a deliverer. Furthermore, after use, the bags 60 can be simply folded together into a flat configuration, occupying little space. If desired, the bags 60 can be equipped with a sealable closure (seal not shown) for the detection of unauthorized opening of the bag, and a label 62 or such identification means, so that the packaged mail can be identified in a simple manner.

As, in the above-described sorting center 1, the sorting cabinets 5 have been uncoupled from the combining tables 8, a more flexible use of both units 5, 8 is possible. The sorting cabinets 5 can then be used more intensively, so that fewer cabinets 5 are required. The space that becomes thus available can be utilized for the installation of buffers G, H so that a sorting center 1 according to the invention requires no additional space.

In order to utilize the obtained flexibility still more effectively, the districts (or “rounds”) and associated mail can be subdivided into smaller portions, for instance in so-called sub-districts (or “round-portions”). To that end, for instance at any moment during machine-sorting and hand-sorting of the mail flows P₁, P₂, separating means (not shown) can be arranged between the mail, in the form of, for instance, cards, preferably of a clearly marked size or color. These separating means can for instance be inserted between the mail items every so many streets or house numbers. When mail for a particular district threatens to incur a delay, the flow can simply be subdivided into sub-flows for the separate sub-districts, which sub-flows can then be sorted and/or combined simultaneously instead of sequentially. As a result, the run-through time can be considerably reduced and the delay can be made up for. With, for instance, a subdivision into two sub-districts, the run through time can be reduced by 50%, with three sub-districts by 66%, and with four sub-district by 75%, et cetera. It will be clear that the finer the subdivision into sub-districts, the greater the time profit to be obtained. Thus, in a simple manner, the mail can be processed in time, waiting times between successive processing steps can be reduced, and these successive processing steps (such as sorting, combining and/or delivering) can therefore be contracted out easier to different independent persons.

In a particularly advantageous embodiment, the separating means can further comprise instructions or other relevant information with regard to the respective sub-district and/or operations to be carried out to the mail. This information can be provided on the separating means before and/or when the various operations are being traversed. To that end, these separating means may for instance be provided with a writable surface or a storing medium. Due to such information, the personnel itself, carrying out the work, needs not have any specific knowledge, so that this personnel can be used even more flexibly. Naturally, such knowledge may also have been added for an entire district, for instance on information carriers carried along with the mail, such as instruction cards or other types of communication means. On such information carriers, also, possible specifics with regard to the preceding processing steps can be stored.

In the following, an advantageous embodiment of a sorting cabinet 5 according to the invention will be described with reference to FIG. 2. The cabinet 5 shown comprises two wheeled halves 11, 12, which are pivotally interconnected about a substantially vertical middle support 14. This middle support 14 is provided on a front and a rear side with a height adjustable leg 13 (see FIG. 2B) on which the cabinet, in rest, can be supported in a stable manner.

Each cabinet half 11, 12 is subdivided into cubicles 15, each representing a particular sorting destination, indicated by, for instance, a postal code, district, sub-district, street or house number, depending on the sorting step to be carried out with the cabinet 5. In order to indicate these sorting destinations, the cubicles 15 are provided with identification means 16, for instance a nameplate. Preferably, these nameplates are erasable or rewritable, so that the sorting destination can be changed in a simple manner. In a particularly advantageous embodiment, the identification means 16 comprise a series of programmable screens on which the sorting destinations can be represented. This offers the advantage that the sorting destinations can be adapted in a simple manner, so that the sorting cabinet 5 is flexibly usable for various sorting steps and sorting destinations. These sorting destinations can for instance be entered by hand, via suitable control means 18 which may have been provided on the middle support 14. In an advantageous embodiment, the middle support 14 can be provided with memory means, in which different sorting programs with sorting destinations can be pre-programmed. As a result, a user can set all sorting destinations in one go, through selection of the desired sorting program, for instance with earlier mentioned control means 18. Furthermore, the sorting destinations of these sorting programs can be adapted in a simple manner to the sorting destinations of the machine-sorted mail flow P₁. The sorting programs can further comprise additional information regarding the sorting process. This information can for instance be represented on the identification means 16, so that the identification means 16 can assume the function of the earlier-mentioned instruction cards. Further, the sorting programs can determine the order in which the sorting destinations are represented below the cubicles 15. As a rule, this will be in alphabetical order, which simplifies sorting but alternative orders are conceivable. The sorting programs can also comprise information regarding the order in which, after the sorting session, the cubicles 15 are to be emptied. Thus, the mail can be laid in a desired order (corresponding to, for instance, the order of the machine-sorted mail P₁ and/or the delivery order) without the sorter needing to know this order by heart. The desired order can for instance be indicated with successive numbers on the identification means 16. Alternatively, use can be made of, for instance, a light or similar indicator, lighting up at the respective sorting cubicle 15 when it is its turn to be emptied.

In the exemplary embodiment shown, both cabinet halves each comprise thirty-two cubicles 15 grouped in eight rows of four. These numbers should not be taken as being limitative in any manner but, in the example shown, they have been selected for a particular purpose, i.e. such that the number of rows is greater than the number of rows required. Traditionally, most districts are selected such that they comprise these forty-eight sorting destinations. In the present case this means that the sorting cabinet 5 has sixteen cubicles, or two rows, more than required. That is why, when programming the identification means 16, only a part of the available rows will be utilized, for instance the top six rows, the bottom six rows or the middle six rows. Thus, the working height can be set to a certain extent. Prior to a sorting session, the rows to be used can for instance be entered by a user with the aid of earlier mentioned control means 18. Naturally, other height adjusting means can be provided, such as a screw spindle or piston cylinder assembly. However, a height adjustment according to the invention offers the advantage that it is very simple from a constructional point of view, it requires no moving or additional parts and requires hardly any energy. Furthermore, the control means 18 and/or the sorting programs can simply be designed such that it is mandatory to set the working height at the start of the sorting session, and a user can thus be forced to an ergonomically safe use. Optionally, in a comparable manner, only a part of the columns can be used, so that a working width of the cabinet 5 can be adjusted, to a certain extent, to the reach of a user. As an alternative, or in addition thereto, this latter can be adjusted by pivoting the cabinet halves 11, 12 towards each other to a greater or smaller extent.

Thus, a sorting cabinet 5 according to the invention can be adapted to the physical build of various users, thereby increasing the usability of the cabinet 5 and the users. Furthermore, when not in use, the cabinet 5 can be put away in a compact manner, occupying little space, by pivoting the cabinet halves 11, 12 towards each other.

A cabinet 5 according to the invention therefore offers the advantage that it is very flexibly usable due to the wheeled arrangement and the easy- to-adjust cubicle division 15 with programmable sorting destinations. In addition, the cabinet 5 requires no specific sorting knowledge, as all required knowledge can be included in the pre-programmed sorting programs. Moreover, the cabinet 5 is user-friendly due to the adjustable working height and/or width. Hence, a sorting cabinet 5 according to the invention is eminently suited for use in a sorting center 1 and method according to the invention, which is directed to having the sorting process proceed more flexibly through a more flexible use of manpower and means.

It is expressly noted that use of a sorting cabinet 5 according to the invention or aspects thereof are not limited in any manner to a sorting center or method according to the invention. For instance, the sorting cabinet can be advantageously used in other sorting processes, for instance in a traditional sorting process wherein hand-sorting and combining of mail is coupled in time, place and/or personnel carrying out the work.

It is further noted that many variations are possible on the embodiment shown in FIGS. 2A, B. For instance, the sorting cabinet 5 may be designed in one piece, without pivotal parts, or, conversely, comprise more than two pivotable parts. The number of cubicles 15 can differ per cabinet part 11, 12. These and many other variations are understood to fall within the framework of the invention as outlined by the claims.

The buffer for sorting out mail G, shown in FIG. 1, is built up from four buffer assemblies 9 arranged next to each other, of which a possible exemplary embodiment according to the invention is represented in further detail in FIGS. 3B, C. This shown buffer assembly 9 comprises a static buffer part 6 with three storage levels 21, 22, 23 located above each other (see FIG. 3A), with each storage level 21, 22, 23 comprising two rows located next to each other, each offering space to five mail carriers 3 (see FIG. 3C). These numbers only serve as illustration and should not be construed as being limitative in any manner. It is preferred that each row 25 be reserved for one particular district, so that the mail P₂ can be stored in the buffer G sorted to district. If necessary, for very large districts, more than one row can be reserved. If desired, for identifying the different districts, use can be made of nameplates or similar programmable identification means (not shown) as used in the sorting cabinets 5. The rows 25 can further comprise transport means 28 for moving the mail carriers 3 between the various storage locations. In the exemplary embodiment shown, these transport means 28 have the form of a slightly slopingly arranged roller path provided with freely rotating rollers with which, under the influence of gravity, the mail carriers 3 can move from an entrance side (indicated with arrow I) to an exit side (indicated with arrow U) as may possibly be seen most clearly in FIG. 3C. Naturally, many other transport means 28 are possible such as, for instance, driven transport chains or belts, or wheeled trolleys. Further, blocking means can be provided (not shown) for blocking one or more rollers and thus stop the movement of the mail carriers 3.

The buffer assembly 9 can further be provided, adjacent the entrance side I and/or exit side U, with a wheeled buffer part 4A, B (see FIGS. 3D, E) which, as desired, can be coupled to the static buffer part 6 and thus provide additional buffer capacity, or, conversely, can be uncoupled and then serve as transport trolleys 4A, B for transport of the various mail flows between the different zones of the sorting center 1. Earlier-mentioned blocking means are preferably designed such that the transport means 28 are blocked when one of the trolleys 4A, B is uncoupled. In this manner, the mail carriers 3 are prevented from being unwontedly discharged from the storage buffer 6.

The buffer assembly 9 can be used as follows. The mail flow P₂ to be hand-sorted can comprise a number of sorts of mail, among which “large” mail which is too large to be machine-sorted, “bundle” mail, such as for instance certain magazines which have already been bundled for instance to district by the dispatcher and possible by direction of the sorting center, and/or “miscellaneous” mail, which, as to size, can but as to other reasons cannot be processed by a sorting machine, for instance because the destination is unreadable or the mail has been packaged in plastic.

The “large” mail and “bundle” mail are, in as far as necessary and possible, sorted to district in the pre-sorting zone B, while the earlier mentioned buffer trolley or rear trolley 4A is used as “sorting” trolley. To this end, this buffer trolley 4A is designed such that mail carriers 3 placed therein assume a slightly tilted position, as can best be seen in FIGS. 3C and 3E. Such a tilted position improves the accessibility of the mail carriers 3 so that the “large” and/or “bundled” mail can be placed in the carriers 3 more easily. Then, the “large” and “bundle” mail, sorted to district, is transported in these trolleys 4A (FIG. 3C) to the buffer for sorting mail G, and, at that location, at the entrance side I (FIG. 3C) placed in the buffer assembly 9 in a row 25 reserved for the respective district.

If necessary, the “miscellaneous” mail is first hand-sorted to district in sorting zone D with the aid of the sorting cabinets 5, and then brought to the buffer assembly 9 with trolley type 4B (also called front trolley) and at that location, coupled to the exit side U (see FIG. 3C) so that the mail, sorted to district, is stored in this buffer assembly 9. It is preferred that the front trolley 4B be designed such that mail carriers 3 placed thereon are slowed down in a natural manner, for instance by replacing at least a number of rollers 28 with a metal plate 29 as can be seen in FIGS. 3B and 3D.

The “large” mail, “bundle” mail and “miscellaneous” mail thus stored is then sorted to house number in sorting zone D, with the aid of the sorting cabinets 5, in an earlier described manner. If necessary, this can be carried out in successive steps, while the sorting destinations between successive sorting steps can be adjusted in a simple manner by selecting a suitable sorting program, while between the respective steps, the mail can be temporarily returned to the buffer zone G (sorted to district). The thus hand-sorted mail P₂ is then brought from the sorting cabinets 5 to the combining buffer H. Preferably, use is made here of a combining trolley 30, as represented in FIGS. 4A-D.

This combining trolley 30 comprises a wheeled undercarriage 32 provided with a first worktop 33 for two mail carriers 3 and a second worktop 34 extending thereabove, also for two mail carriers 3. Relative to the first worktop 33, this second worktop 34 is slightly tilted about a longitudinal axis. On the low side 34A of the second worktop 34, a support rod 35 is provided which is at approximately the same height as the high side 34B of the second worktop 34 and, with it, forms a substantially horizontal third worktop 36 (as represented in interrupted lines). Further, above these worktops 33, 34, 36, a suspension structure 37 is provided from which two further mail carriers 3 can be suspended as shown in FIG. 4B. Here, these mail carriers 3 assume a tilted position which is opposite that of the second worktop 34. The combining trolley 30 further comprises a push bracket 38. In the embodiment shown, the combining trolley 30 comprises four wheels, two of which are designed as castors. In alternative embodiments, more castors 40 can be provided, for instance four. Preferably, at least one of these wheels 40 has a brake (not shown), in order to block the combining trolley 30 at standstill. Further, at the bottom side of the first, lowest worktop 33, a guiding channel 39 is provided (of which only one diverging entrance part is visible in FIGS. 4B and 4C), which can fittingly slide around a leg of the earlier described combining table 8 and can thus serve as guiding provision for positioning the combining trolley 30 correctly relative to this table 8.

The above-described combining trolley 30 can be used in various manners. For instance, the trolley 30 can be deployed when emptying a sorting cabinet 5. For the purpose of this function, the mail carriers 3 are preferably suspended in the highest position, as shown in FIG. 4B, in which position they have a comfortable working height for inserting the mail. This insertion is even further facilitated by the somewhat forward tilted position of the carriers.

Then, the combining trolley 30 can be used for transporting the mail to the combining buffer H. At that location, the mail carriers 3 filled with hand-sorted mail are placed from the top position (FIG. 4B) on the second, tilted worktop 34 or the third, horizontal worktop 36. Then, the trolley 30 forms a district-restricted mini-buffer (the district corresponding to the district of the hand-sorted mal). Then, machine-sorted mail P₁ destined for that same district can be placed on the lower worktop 33. This mail P₁ for that matter may also have already been placed on the combining trolley 30 before this is used to empty a sorting cabinet 5 (as shown in FIG. 4B). When the combining trolley 30 has thus been filled with machine-sorted and hand-sorted mail P_{1, 2}, as shown in FIG. 4C, the trolley 30 is brought to the combining zone E. The guiding channel 39, in cooperation with a leg of the combining table 8, then ensures foolproof positioning of the trolley 30 relative to the combining table 8. In this position, the top row of mail carriers 3 can be placed in a simple manner in a tilted position (as shown in FIG. 4D) by lifting the mail carriers 3 on one side of the support rod 35 and placing them on the second worktop 34 (if they are not already resting thereon). The tilting direction of this second worktop 34 is chosen such that a person seated at the combining table 8 obtains a good view of the contents of the mail carriers 3, in particular the addresses.

After the mail P1, 2 has been combined, in an earlier described manner, the combining trolley 30 can be used as worktop for packaging combined and bundled mail, for instance in an inner bag 60 as described hereinabove with reference to FIGS. 8A, B. To this end, this inner bag 60 may have been placed in a mail carrier 3, which mail carrier 3 in turn may have been placed on the horizontal third worktop 36 or, optionally, on the tilted second worktop 34 of the combining trolley 30 (see FIG. 4C). Here, the mail carrier 3 ensures support and/or stabilisation of the bag 60, and the combining trolley 30 with the referred-to worktops 34, 36 ensures a working height suitable for packing. It will be clear that in this manner, due to the different work levels and the guiding provision, the combining trolley 30 according to the invention is usable in a multifunctional manner.

In FIG. 5, a further transport trolley 40 is shown, with which mail can be transported between at least a number of the different processing zones A-F and/or buffers G, H. The trolley 40 is provided with a horizontal worktop 41 suitable for four mail carriers 3, and two worktops 42A, B located thereabove, tilted in opposite directions, each suitable for two mail carriers 3. These tilted worktops 42A, B can, again, function as worktop for mail carriers 3 placed thereon, while the height and the tilting angle can be chosen such that in a simple manner, mail can be introduced into the mail carries 3 or, conversely, be taken therefrom. Further, it is preferred that the one worktop 42A, in its entirety, is situated somewhat higher than the other worktop 42B, as illustrated in FIG. 5. As a result, with the respective operation, a user can each time chose a working height which is most convenient for him. Naturally, to that end, the trolley can also be provided with, for instance, a height-adjustable worktop. Further, the trolley 40 can be provided with more worktops and/or larger worktops, suitable for more mail carriers 3.

Such a trolley 40 can for instance be advantageously used for transporting “miscellaneous” mail P₂ to be hand-sorted between the buffer for sorting out mail G and the sorting zone D. Here, the worktops 42A, B staggered in height offer a sorter the possibility to choose a take-out height which is best for him. Moreover, the tilting ensures a good view on the content of the mail carriers 3, which facilitates taking out. In addition, the transport trolley 40 according to the invention can be used for transporting machine-sorted mail P₁ from the sorting zone C to the combining buffer H. In that case, the different worktops 42A, B offer the advantage that machine-sorted content of each mail carrier 3 is directly visible and accessible, so that this mail is, as it were, “randomly” accessible and can be instantaneously recognized, which is not possible with, for instance, transport trolleys in which the mail carriers 3 are stacked on top of each other. It will be clear that for the different transport purposes many other trolleys are possible.

The invention is not limited in any manner to the exemplary embodiments represented in the description and the drawing. All combinations of (parts of) embodiments described and/or shown are understood to fall within the inventive concept. Furthermore, many variations thereon are possible within the framework of the invention, as set forth in the following claims.

1. A sorting center for sorting and combining mail, comprising sorting units for hand-sorting mail and combining units for combining hand-sorted mail and other mail into a single flow of sorted mail, which other mail has for instance already been sorted elsewhere or is machine-sorted, characterized in that the combining units are physically separated from the sorting units and can be used independently of each other.

2. A sorting center according to claim 1, comprising at least one buffer for storage of mail to be sorted and/or to be combined.

3. A sorting center according to claim 1, comprising transporting means for transport of mail to the sorting and/or combining units.

4. A sorting center according to claim 2, wherein at least one part of the at least one buffer is wheeled, and can function as transport means for transporting mail to the sorting and/or combining units.

5. A sorting center according to claim 2, wherein the or each buffer and/or the transporting means are provided with destination-restricted storage positions, for storage to a particular destination area, for instance a region, district or sub-district.

6. A sorting center according to claim 2, wherein the wheeled buffer parts and/or transport means are provided with different storage levels.

7. A sorting center according to claim 2, wherein the wheeled buffer parts and/or transport means are provided with guiding provisions designed for cooperation with guiding provisions adjacent a combining unit and/or sorting unit, for unambiguous positioning of the respective buffer part or transport means adjacent said unit.

8. A sorting center according to claim 1, wherein the sorting units are arranged in a sorting zone and the combining units are arranged in a combining zone, and wherein, between the two zones, a zone with wheeled, destination-restricted storage buffers is provided.

9. A sorting cabinet for hand-sorting mail, comprising a number of sorting cubicles, which are each provided with a programmable identification means (16), designed for representing a sorting destination.

10. A sorting cabinet according to claim 9, comprising memory means for storing one or more sorting programs, each provided with a series of sorting destinations belonging to a particular delivery area, and control means for controlling the different identification means (16) on the basis of these sorting programs.

11. A sorting cabinet according to claim 10, wherein the sorting programs contain information regarding a particular order in which the sorting destinations can be coupled to the sorting cubicles and/or the sorting cubicles can be emptied.

12. A sorting cabinet according to claim 9, wherein the height of the sorting cubicles is adjustable.

13. A sorting cabinet according to claim 9, in which the width of the cabinet is adjustable.

14. A sorting cabinet according to claim 9, wherein the number of sorting cubicles is greater than the number of sorting destinations per delivery area such that a desired working height and/or working width is adjustable by using only a part of the available rows and/or columns of sorting cubicles.

15. A sorting cabinet according to claim 9, wherein control means of the sorting cabinet are designed such that, prior to use, it is mandatory to set user-dependent working conditions such as for instance the working height, right-handedness or left-handedness.

16. A sorting cabinet according to claim 9, comprising at least two cabinet parts which are mutually pivotally connected.

17. A sorting cabinet according to claim 16, wherein the cabinet parts are pivotable about a substantially vertical pivot.

18. A sorting cabinet according to claim 9, wherein the cabinet, or parts thereof, are wheeled.

19. A buffer assembly comprising a static buffer part and at least one wheeled buffer part that can be coupled and uncoupled, the static buffer part comprising a number of storage positions located next to each other and/or above each other, the at least one wheeled buffer part comprising storage positions which link up therewith so that this buffer part, in coupled condition, forms an extension of the buffer and in uncoupled condition forms a transport means.

20. A buffer assembly according to claim 19, comprising transport means for transporting stored goods to the different storage positions, and blocking means for blocking or switching off transport means when the at least one wheeled buffer part has been or is uncoupled.

21. A sorting center according to claim 2, wherein the buffer comprises at least one buffer assembly comprising a static buffer part and at least one wheeled buffer part that can be coupled and uncoupled, the static buffer part comprising a number of storage positions located next to each other and/or above each other, the at least one wheeled buffer part comprising storage positions which link up therewith so that this buffer part, in coupled condition, forms an extension of the buffer and in uncoupled condition forms a transport means.

22. A sorting center comprising sorting units for hand-sorting mail and combining units for combining hand-sorted mail and other mail into a single flow of sorted mail, which other mail has for instance already been sorted elsewhere or is machine-sorted, characterized in that the combining units are physically separated from the sorting units and can be used independently of each other, wherein the sorting units comprise at least one sorting cabinet according to claim 9.

23. A method for sorting mail, wherein a first mail flow is hand-sorted, and is then combined with a second mail flow, for instance unaddressed mail or automatically sorted mail, resulting in a single flow of sorted mail, while the combining is carried out at a different location and preferably by other persons than the hand-sorting of the first mail flow.

24. A method according to claim 23, wherein, prior to the combining, the first and or second mail flow are stored in a buffer, preferably a destination-restricted, at least partly mobile buffer.

25. A method according to claim 23, wherein the mail for a particular delivery area is sorted to order of delivery destination.

26. A method according to claim 23, wherein, when traversing the different process steps, the mail flows are subdivided into sub-flows corresponding to particular areas of delivery, while per sub-flow information carriers are added with knowledge and/or instructions regarding sorting and/or combining operations to be carried out to the respective sub-flows.

27. A method according to claim 23, wherein the mail flows to be combined involve addressed mail, and wherein possible unaddressed mail is held separate until the moment the addressed mail is delivered at a final destination.

28. A sorting center comprising sorting units for hand-sorting mail and combining units for combining hand-sorted mail and other mail into a single flow of sorted mail, which other mail has for instance already been sorted elsewhere or is machine-sorted, characterized in that the combining units are physically separated from the sorting units and can be used independently of each other, wherein the sorting units comprise at least one sorting cabinet-according to claim and a buffer assembly according to claim 9 and a buffer assembly comprising a static buffer part and at least one wheeled buffer part that can be coupled and uncoupled, the static buffer part comprising a number of storage positions located next to each other and/or above each other, the at least one wheeled buffer part comprising storage positions which link up therewith so that this buffer part, in coupled condition, forms an extension of the buffer and in uncoupled condition forms a transport means.
